(19) United States
(12) Patent Application Publication
(10) Pub. No.: US 2026/0140482 A1
(43) Pub. Date: May 21, 2026

(54) Electronic Devices With Surface Touch Sensors

(71) Applicant: Apple Inc., Cupertino, CA (US)

(72) Inventors: Nurul Islam, Mountain View, CA (US); Dan Nussinson, Haifa (IL); Arun Srivatsan Rangaprasad, San Jose, CA (US); Michael C Wharton, San Jose, CA (US)

(21) Appl. No.: 19/325,966

(22) Filed: Sep. 11, 2025

Related U.S. Application Data
(60) Provisional application No. 63/722,915, filed on Nov. 20, 2024.

(51) Int. Cl. G04G 21/08; G04G 21/02; G06F 3/042

(52) U.S. Cl. CPC G04G 21/08; G04G 21/02; G06F 3/0421

(57) ABSTRACT

An electronic device, such as a wearable electronic device (e.g., a wristwatch device) may include one or more surface touch sensors to detect taps, touches, and/or other interactions between a user's hand and an external surface. The device may include a housing with a front surface, a rear surface, and a sidewall that extends from the front surface to the rear surface. The surface touch sensor may operate through a sensor window in the sidewall, such as through a crown. The surface touch sensor may include a light emitter and a light detector. The light emitter may emit light that reflects off a hand of a user as reflected emitted light, and the light detector may measure the reflected emitted light to detect taps of the hand of the user on an external surface. The electronic device and/or an external electronic device may be adjusted based on the detected taps.

This application claims the benefit of U.S. provisional Ser. No. 63/722,915 , filed Nov. 20, 2024, which is hereby incorporated by reference herein in its entirety.

### FIELD

This relates generally to electronic devices, including electronic devices with sensors.

### BACKGROUND

Electronic devices such as laptop computers, cellular telephones, and other equipment are sometimes provided with sensors, such as ambient light sensors, image sensors, and microphones.

### SUMMARY

An electronic device, such as a wearable electronic device (e.g., a wristwatch device) may be provided with a housing and one or more surface touch sensors in the housing. The device may include a front surface, a rear surface, and a sidewall that extends from the front surface to the rear surface. The surface touch sensor may operate through a sensor window in the sidewall, such as through a crown on the sidewall.

Each of the surface touch sensors may include a light emitter and a light detector. The light emitter may emit light toward the hand of a user, such as toward the dorsum of the hand. The light may reflect off of the hand as reflected emitted light. The light detector may measure the reflected emitted light to detect taps, swipes, touches, hand gestures, and/or other interactions with an external surface.

The electronic device and/or an external electronic device may be adjusted based on the detected taps and/or other interactions detected on the external surface. For example, an operation of the device may be adjusted. The surface touch measurements may be gated by a trigger event, such as an operating state of the electronic device or an input from a sensor, such as from a microphone or a motion sensor.

### BRIEF DESCRIPTION OF THE DRAWINGS

FIG. 1 is a drawing of an illustrative wearable electronic device in accordance with some embodiments.

FIG. 2 is a diagram of an illustrative electronic device in accordance with some embodiments.

FIG. 3 is a side view of an illustrative surface touch sensor in a wearable electronic device that detects taps and/or other interactions from a user's hand on an external surface in accordance with some embodiments.

FIG. 4 is a schematic diagram of an illustrative surface touch sensor inn accordance with some embodiments.

FIG. 5 is a graph of an illustrative frequency modulation that may be used to measure taps and/or other interactions on an external surface using a surface touch sensor in accordance with some embodiments.

FIG. 6 is a graph of an illustrative transformed surface touch sensor measurement that may be used to determine taps and/or other interactions on an external surface in accordance with some embodiments.

FIG. 7 is a flowchart of illustrative method steps that may be used to detect a tap or hand gesture on an external surface and to adjust a device based on the detected tap or hand gesture in accordance with some embodiments.

### DETAILED DESCRIPTION

Electronic devices, such as wearable electronic devices (e.g., wristwatch devices), are often carried/worn by users as they conduct their daily activities. For example, a user may wear an electronic device on their person throughout the day while walking, commuting, working, exercising, etc. In some situations, it may be desirable for the user to provide input to the electronic device. For example, it may be desirable to provide input to the electronic device without touching the electronic device. Therefore, a surface touch sensor may be incorporated into electronic devices.

In particular, a surface touch sensor may include a light source and a light detector. The light source may emit light toward a user's hand (e.g., toward the dorsum of the user's hand). The emitted light may reflect off of the user's hand as reflected emitted light. The reflected emitted light may be detected by the light detector. Based on the reflected emitted light measured by the light detector, it may be determined that the user has touched (e.g., tapped on), swiped (e.g., swipes from a finger that is touched and dragged), and/or otherwise interacted with an external surface. In response to a determination that the user has touched, tapped, or otherwise interacted with the external surface, the electronic device may be adjusted. In this way, taps/touches on an external surface may be detected by a surface touch sensor and may be used to provide input to, and to adjust, an electronic device.

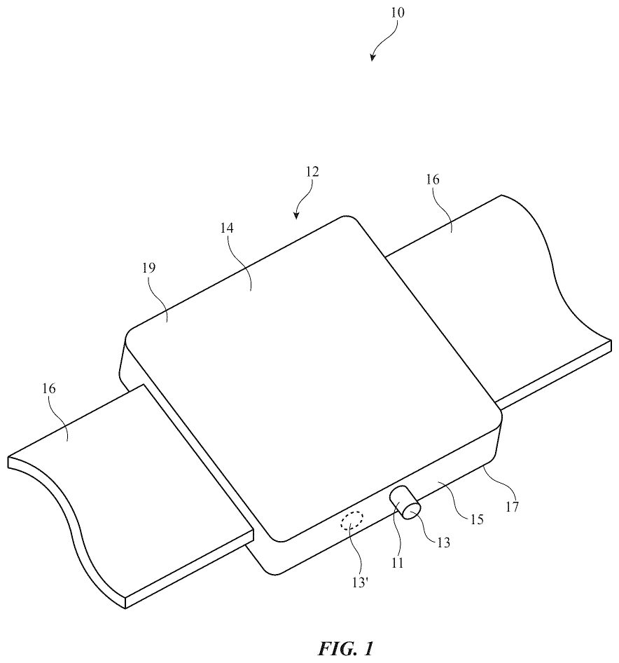

In general, any suitable electronic devices may include surface touch sensors. As shown in FIG. 1, wearable electronic device 10, which may be a wristwatch device, may have housing 12 (also referred to as wristwatch housing 12 herein). Housing 12 may include front surface 19, rear surface 17, and sidewall(s) 15. The one or more sidewalls 15 may extend between front surface 19 and rear surface 17 (e.g., may extend from front surface 19 to rear surface 17). A display, such as display 14, may be formed on front surface 19. One or more input devices, such as crown 11, a button, and/or other input devices, may be formed on one or more of sidewalls 15. Crown 11 may be rotated, depressed, touched, and/or otherwise manipulated to provide input to device 10. Strap 16 may be coupled to housing 12, such as at one or more of sidewalls 15. The wristwatch may attach to a user's wrist via strap 16.

One or more surface touch sensors may be incorporated into housing 12, such as on one or more sidewalls 15 of housing 12. For example, crown 11 may have sensor window 13 through which a surface touch sensor operates. In other words, the surface touch sensor may be formed within crown 11. Sensor window 13 may be an opening, a cavity, or may be formed from a structure transparent to the wavelength(s) of light emitted by and/or detected by the surface touch sensor.

Alternatively or additionally, a sensor window may be formed along one or more of sidewalls 15 apart from crown 11 (or crown 11 may be omitted entirely). For example, a sensor window may be formed in location 13′ on sidewall 15. A surface touch sensor may be located in housing 12 and operate through the sensor window in location 13′.

The locations of sensor window 13 in FIG. 1 are merely illustrative. In general, a sensor window for an underlying surface touch sensor may be formed on any suitable surface of housing 12, such as front surface 19, rear surface 17, or one of sidewalls 15. Additionally or alternatively, multiple surface touch sensors may be included in device 10, and the multiple touch sensors may operate through shared sensor windows and/or have multiple dedicated sensor windows.

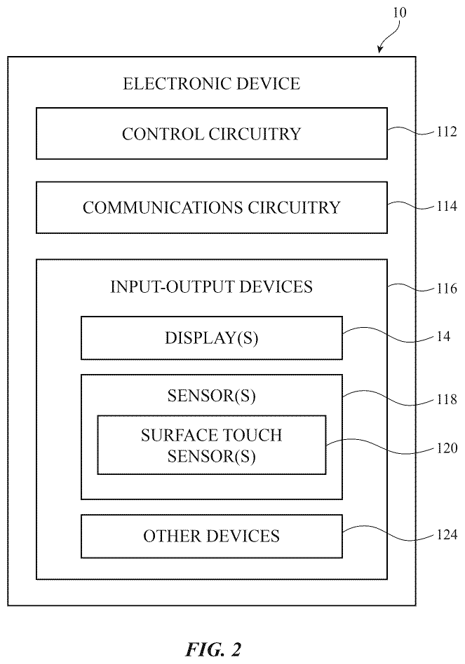

Although FIG. 1 shows electronic device 10 as a wristwatch device, this example is merely illustrative. In general, electronic device 10 may be any desired device, such as a media player or other handheld or portable electronic device, a cellular telephone device, a wristband device, a pendant device, a headphone, a speaker, a smart speaker, an ear bud or earpiece device, a head-mounted device such as glasses, goggles, a helmet, or other equipment worn on a user's head, or other wearable or miniature device, a portable computer (e.g., a laptop computer or a tablet computer), a desktop computer, a navigation device, or other accessory, and/or equipment that implements the functionality of two or more of these devices. Illustrative configurations in which electronic device 10 is a portable electronic device such as a wristwatch device may sometimes be described herein as an example. Regardless of the form factor of device 10, an illustrative schematic diagram of device 10 is shown in FIG. 2.

As shown in FIG. 2, an electronic device such as electronic device 10 may have control circuitry 112. Control circuitry 112 may include storage and processing circuitry for controlling the operation of device 10. Circuitry 112 may include storage such as hard disk drive storage, nonvolatile memory (e.g., electrically-programmable-read-only memory configured to form a solid-state drive), volatile memory (e.g., static or dynamic random-access-memory), etc. Processing circuitry in control circuitry 112 may be based on one or more microprocessors, microcontrollers, digital signal processors, baseband processors, power management units, audio chips, graphics processing units, application specific integrated circuits, and/or other integrated circuits. Software code may be stored on storage in circuitry 112 and run on processing circuitry in circuitry 112 to implement control operations for device 10 (e.g., data gathering operations, operations involving the adjustment of the components of device 10 using control signals, etc.).

Electronic device 10 may include communications circuitry 114, which may include wired and/or wireless communications circuitry. For example, electronic device 10 may include radio-frequency transceiver circuitry, such as cellular telephone transceiver circuitry, wireless local area network transceiver circuitry (e.g., WiFi® circuitry), short-range radio-frequency transceiver circuitry that communicates over short distances using ultra high frequency radio waves (e.g., Bluetooth® circuitry operating at 2.4 GHz or other short-range transceiver circuitry), millimeter wave transceiver circuitry, and/or other wireless communications circuitry.

Device 10 may include input-output devices 116. Input-output devices 116 may be used to allow a user to provide device 10 with user input. Input-output devices 116 may also be used to gather information on the environment in which device 10 is operating. Output components in devices 116 may allow device 10 to provide a user with output and may be used to communicate with external electrical equipment.

Input-output devices 116 may include one or more optional displays such as display 14. Display 14 may be an organic light-emitting diode display or other display with light-emitting diodes, a liquid crystal display, a microLED display, or other display. Display 14 may be touch sensitive (e.g., display 14 may include two-dimensional touch sensors for capturing touch input from a user) or display 14 may be insensitive to touch.

Input-output devices 116 may include one or more sensors 118. Sensors 118 may include, for example, three-dimensional sensors (e.g., three-dimensional image sensors such as structured light sensors that emit beams of light and that use two-dimensional digital image sensors to gather image data for three-dimensional images from light spots that are produced when a target is illuminated by the beams of light, binocular three-dimensional image sensors that gather three-dimensional images using two or more cameras in a binocular imaging arrangement, three-dimensional lidar (light detection and ranging) sensors, three-dimensional radio-frequency sensors, or other sensors that gather three-dimensional image data), cameras (e.g., infrared and/or visible digital image sensors), gaze tracking sensors (e.g., a gaze tracking system based on an image sensor and, if desired, a light source that emits one or more beams of light that are tracked using the image sensor after reflecting from a user's eyes), touch sensors, capacitive proximity sensors, light-based (optical) proximity sensors, other proximity sensors, force sensors, sensors such as contact sensors based on switches, gas sensors, pressure sensors, moisture sensors, magnetic sensors (e.g., a magnetometer), audio sensors (microphones), ambient light sensors, temperature sensors, microphones for gathering voice commands and other audio input, sensors that are configured to gather information on motion, position, and/or orientation (e.g., accelerometers, gyroscopes, pressure sensors, compasses, and/or inertial measurement units that include all of these sensors or a subset of one or two of these sensors), health sensors that measure various biometric information (e.g., heartrate sensors, such as a photoplethysmography sensor), electrocardiogram sensors, and perspiration sensors) and/or other sensors.

Sensors 118 may also include one or more surface touch sensors 120. Surface touch sensors 120 may be, for example, touch sensors that include a light emitter and a light detector to detect when a user's hand taps, touches, swipes (e.g., touches and drags of a finger), or otherwise interacts with an external surface (e.g., an external object, a surface of the user, or another suitable surface). For example, the light emitter may emit light toward the dorsum or other suitable portion of the user's hand. The light detector may measure emitted light that has reflected off of the user's hand (referred to as reflected emitted light herein). Control circuitry in device 10, such as control circuitry 112, may detect taps and/or other interactions with the external surface based on the reflected emitted light.

If desired, input-output devices 116 may include other devices 124 such as haptic output devices (e.g., vibrating components), light-emitting diodes and/or other light sources, speakers such as ear speakers for producing audio output, circuits for receiving wireless power, circuits for transmitting power wirelessly to other devices, batteries and/or other energy storage devices (e.g., capacitors), joysticks, buttons, and/or other components.

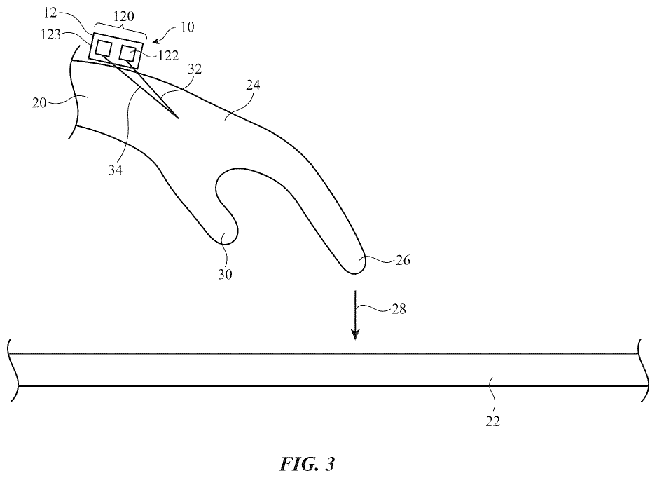

Surface touch sensor(s) 120 may be formed in housing 12 (FIG. 1) of device 10 and may include one or more light emitters and one or more light detectors that detect emitted light that has reflected off a user's hand to detect interactions with an external surface. An illustrative example is shown in FIG. 3.

As shown in FIG. 3, device 10 may include surface touch sensor 120 in housing 12. In the example of FIG. 3, housing 12 is worn on wrist 20 of a user. Surface touch sensor 120 may include light emitter 122 and light detector 123. Light emitter 122 may be a light-emitting diode, a laser, or other suitable light emitter and may emit light 32. For example, light emitter 122 may emit light at infrared wavelengths (e.g., one or more wavelengths between 700 nm and 1 mm, or greater than 1 mm) or other suitable wavelength(s). Light detector 123 may be a photodiode, image sensor, or other suitable light detector that is sensitive to the one or more wavelengths of light emitted by light emitter 122 and/or any other desired wavelengths. In some embodiments, light emitter 122 may emit one or more wavelengths of infrared light and therefore may be referred to as infrared emitter 122, and light detector 123 may detect the one or more wavelengths of infrared light and therefore may be referred to as infrared detector 123. In some illustrative embodiments, light emitter 122 and light detector 123 may form a laser vibrometer. In other words, light emitter 122 may emit coherent beams of light, and reflected light may be detected by light detector 123. In general, however, any suitable light emitter and light detector may be used in surface touch sensor 120.

Light emitter 122 and light detector 123 may be formed in housing 12 in an interior of device 10. To determine whether a user has tapped, touched, swiped, or otherwise interacted with an external surface, light emitter 122 and light detector 123 may operate through a portion of housing 12 (e.g., may emit and receive light through a portion of housing 12). For example, light emitter 122 and light detector 123 may operate through crown 11 (e.g., if surface touch sensor 120 is formed within crown 11) and/or sidewall 15 of housing 12 (FIG. 1).

Light emitter 122 may emit light 32 through a portion of housing 12 that is transparent to the wavelength of light 32. For example, light emitter 122 may emit light 32 through a coated (e.g., coated with one or more filters that allow light 32 to pass while blocking other wavelengths of light) or an uncoated portion of housing 12, or an entire portion of housing 12 may be transparent to the wavelength of light 32.

Light 32 may pass through housing 12 to an exterior of device 10. Light 32 may reflect off of external the dorsum of hand 24 (and/or other suitable portion(s) of hand 24) of a user of device 10 as reflected emitted light 34. Reflected emitted light 34 may pass through a portion of housing 12 that is transparent to the wavelength of reflected emitted light 34. For example, reflected emitted light 34 may pass through a coated (e.g., coated with one or more filters that allow reflected emitted light 34 to pass while blocking other wavelengths of light) or an uncoated portion of housing 12, or an entire portion of housing 12 may be transparent to the wavelength of reflected emitted light 34.

After reflected emitted light 34 has passed into the interior of device 10, reflected emitted light 34 may be detected by light detector 123. In other words, light detector 123 may generate charge or other signals in response to reflected emitted light 34 that is incident on light detector 123.

Circuitry in device 10, such as control circuitry 112 (FIG. 2) may determine whether the user has touched, tapped, swiped, or otherwise interacted with an external surface based on reflected emitted light 34 that is measured by light detector 123. In the illustrative example of FIG. 3, the control circuitry may determine whether has tapped, swiped, or touched external surface 22 with fingertip 26 (e.g., by moving fingertip 26 in direction 28 until it is in contact with external surface 22). Alternatively or additionally, the control circuitry may determine whether thumb 30 contacts/taps external surface 22 or fingertip 26 (e.g.., by bringing thumb 30 and fingertip 26 into contact with one another).

In particular, because light emitter 123 measures reflected emitted light 34 from the dorsum (or other portion) of hand 24, control circuitry 112 may correlate the measured reflected emitted light 34 (e.g., changes in the amount of measured reflected emitted light 34 and/or changes in the phase of reflected emitted light 34) to determine whether the user has tapped, touched, swiped, or otherwise interacted with external surface 22 (or another surface). For example, in embodiments in which surface touch sensor 120 is formed from a laser vibrometer, phase changes of the detected light that has reflected off of hand 24 may be used to determine whether the user has interacted with external surface 22. In general, light 34 that is reflected from hand 24 may be used to determine whether the user has tapped, touched, swiped, or otherwise interacted with a surface, such as external surface 22.

For example, correlations between measured reflected emitted light 34 and taps, touches, swipes, or other interactions of fingertip 26 may be determined using control circuitry 112, which in turn may indicate that a tap, swipe, touch, or other interaction has occurred. These correlations may be determined classically (e.g., determining whether changes in measured reflected emitted light 34 and/or changes in the phase of reflected emitted light 34 exceed a threshold) or using machine learning (e.g., using one or more machine learning algorithms to correlate patterns of the measured reflected emitted light 34 to interactions with the external surface). In this way, control circuitry 112 may determine whether the user has tapped, touched, swiped, or otherwise interacted with a surface, such as external surface 22, based on reflected emitted light 34.

The taps/interactions shown in FIG. 3 are merely illustrative. In some embodiments, surface touch sensor 120 may emit light 32 to differentiate between different fingers of the user tapping, touch, or swiping on an external surface (e.g., by emitting light toward multiple fingers at the dorsum of the hand), and/or multiple surface touch sensors may be used. Alternatively or additionally, surface touch sensor 120 may detect when a user taps, touches, or swipes the dorsum of hand 24 with their additional hand, as the additional hand will interrupt light 32 and/or reflected emitted light 34. In general, however, surface touch sensor 120 may be used to detect taps/interactions between any portion of a user's hand (e.g., hand 24) and a surface (e.g., external surface 22).

Alternatively or additionally, although FIG. 3 shows device 10 being on a top surface of wrist 20 and emitting light 32 to reflect off of the dorsum or other top portion of hand 24, this is merely illustrative. In some embodiments, device 10 may be worn on a bottom surface of wrist 20 and may emit light 32 to reflect off of a bottom surface (e.g., the palm) of hand 24 to detect taps, touches, swipes, and/or other gestures. In general, device 10 may emit light 32 off of any portion of hand 24 and measure reflected light 34 to detect taps, touches, swipes, and/or other gestures.

Although FIG. 3 has shown and described surface touch sensor(s) 120 formed in the interior of an electronic device operating through a housing wall of the electronic device, this is merely illustrative. In some embodiments, the surface touch sensor(s) may be formed in the interior of the electronic device, and the housing may have one or more openings through which the surface touch sensor(s) operate. Alternatively, the surface touch sensor(s) may be formed at the exterior of the electronic device, such as on the housing.

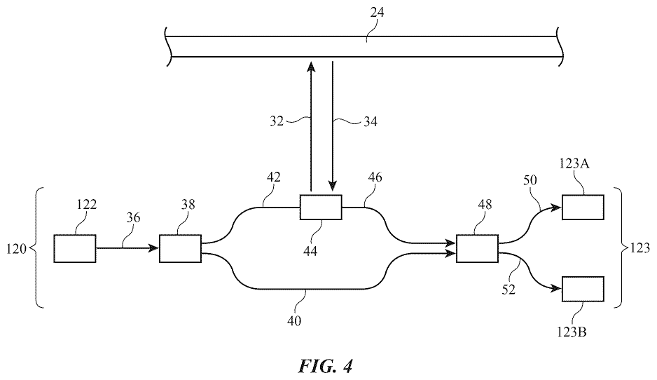

In general, surface touch sensor 120 may include one or more light emitters (e.g., light emitter 122) and one or more light detectors (e.g., light detector 123). In some embodiments, light detector(s) in surface touch sensor 120 may detect reflected emitted light 34, as well as reference light that is received directly from the light emitter(s). An illustrative example is shown in FIG. 4.

As shown in FIG. 4, surface touch sensor 120 may include light emitter 122, optical splitter 38, coupler 44, optical mixer 48, and light detector 123, which may include light detectors 123A and 123B. Light emitter 122 may be a light-emitting diode (LED), a laser, or other suitable light source. Optical splitter 38 may be a 1×2 splitter. Coupler 44 may include one or more lenses, collimators, light-redirection structures, and/or other components. Optical mixer 48 may be a 2×2 mixer. Light detectors 123A and 123B may be photodiodes or other suitable photosensitive elements.

In operation, light emitter 122 may emit light 36 into optical splitter 38, which may split light 36 into light 42 and reference light 40. Light 42 may proceed to coupler 44, which may emit light 32 toward a surface, such as the dorsum of hand 24. The light may reflect off of hand 24 as reflected emitted light 34, which may be received by coupler 44 and pass out of coupler 44 as light 46. Light 46 and reference light 40 may be mixed by optical mixer 48, which may pass output light 50 and 52 to light detectors 123A and 123B, respectively.

Light detectors 123A and 123B may measure light reflected from hand 24 (e.g., reflected emitted light 34) mixed with reference light directly from light emitter 122 (e.g., reference light 40). By measuring the reflected emitted light mixed with reference light, the light emitted by light emitter 122 may be varied over time (e.g., the frequency of emitted light 36 may be varied over time), which may allow for taps, touches, swipes, and other interactions between hand 24 and an external surface to be detected (e.g., based on phase changes of the measured light).

However, the arrangement of FIG. 4 is merely illustrative. In general, surface touch sensor 120 may include any suitable number of light emitters 122 and any suitable number of light detectors 123. Alternatively or additionally, light detectors 123 may detect reflected emitted light 34 without reflected emitted light 34 being mixed with reference light. Reference light 40 may be measured separately from reflected emitted light 34, or reference light may not be measured at all. Therefore, in some embodiments, splitter 38 and/or mixer 48 may be omitted from surface touch sensor 120.

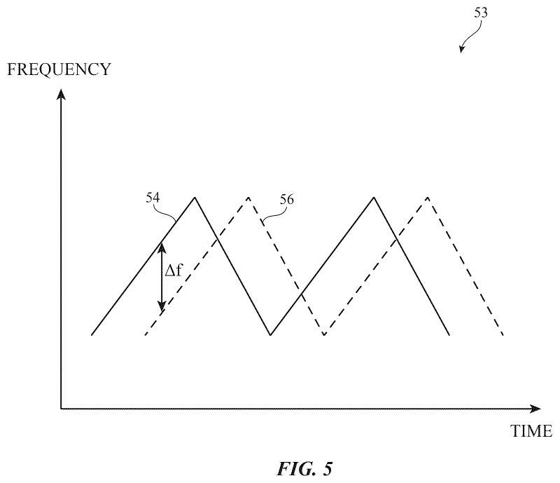

As discussed, the frequency of light emitted by light emitter 122 may be changed to assist with the detection of taps, touches, swipes, and/or other interactions of a user's hand on an external surface. An illustrative example is shown in FIG. 5.

As shown in FIG. 5, graph 53 may give illustrative relationships between frequency and time for light emitted by a light emitter (e.g., light emitter 122 of FIG. 4) and light detected by a light detector (e.g., light detector 123 of FIG. 4) of a surface touch sensor (e.g., surface touch sensor 120 of FIG. 4). In particular, light emission curve 54 may correspond with the frequency of light emitted by the light emitter over time. As indicated by light emission curve 54, the frequency of the emitted light may be varied over time.

Light detection curve 56 may correspond with the frequency of light detected by the light detector over time. The detected light may be reflected emitted light (e.g., light that has reflected off of the hand of the user).

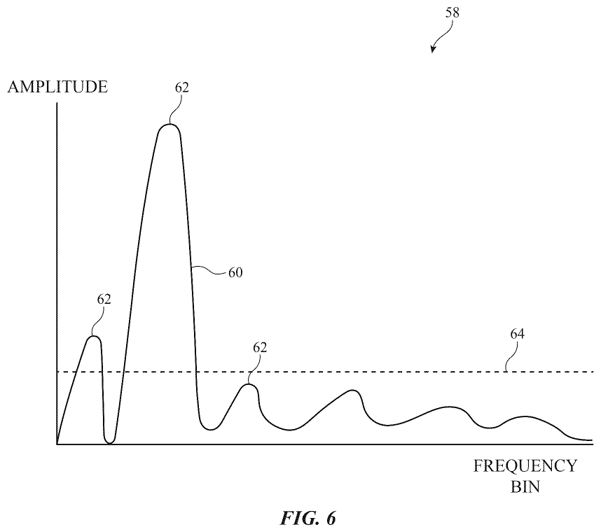

There may be a difference in frequency Δf between light emission curve 54 and light detection curve 56. Due to the varied frequency of light emission curve 54, as well as the difference in frequency Δf, the frequency of light detected by the light detector (e.g., light detection curve 56) may be used to determine whether the user's hand has tapped, touches, swiped, or otherwise interacted with an external surface. For example, a transform, such as a fast Fourier transform (FFT) may be performed on the data corresponding to the light measured by the light detector(s) (e.g., detectors 123 of FIG. 4). An illustrative example is shown in FIG. 6.

As shown in FIG. 6, graph 58 may give an illustrative relationship between amplitude and frequency bins for measurements of light detectors in a surface touch sensor that have undergone one or more transforms, such as an FFT. Illustrative curve 60 may be a sine wave that has peaks 62. Circuitry in device 10, such as control circuitry 112 (FIG. 2) may determine when peaks 62 exceed a threshold, such as threshold 64. Peaks 62 that exceed threshold 64 may correspond with taps, touches, swipes, or other interactions of a user's hand with an external surface. In this way, taps, touches, swipes, and/or other interactions of the user's hand with the external surface may be determined.

Although taps or other interactions may be determined from the transformed data in FIG. 6, the data may undergo additional processing, such as bandpass filtering, additional transforming (e.g., additional FFT), thresholding, and/or other processing prior to determining the taps or other interactions. Additionally or alternatively, a machine-learning algorithm may be used to correlate the transformed data (e.g., the data in FIG. 6 or additionally processed data) to taps, touches, swipes, and/or other interactions with an external surface. As examples, a gradient boosted tree algorithm, random forest algorithm, decision tree algorithm, support vector machine algorithm, multi-layer perceptron algorithm, convolutional neural network algorithm, or other suitable machine-learning algorithm may be used to correlate measurements from a light detector in a surface touch sensor to taps/other interactions on an external surface.

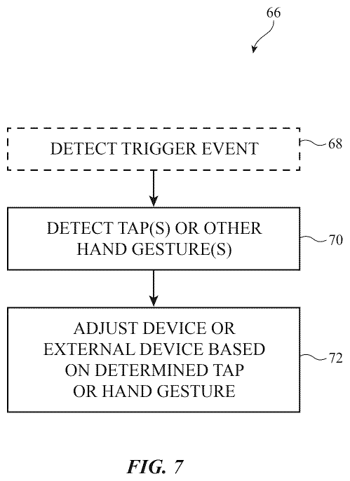

In general, the detected taps/other interactions on an external surface may be used to adjust one or more operations of an electronic device (e.g., electronic device 10 of FIGS. 1 and 2). An illustrative example of method steps that may be used to detect the taps/other interactions and adjust the electronic device are shown in FIG. 7.

As shown in FIG. 7, at step 68 of flowchart 66, a trigger event may optionally be detected to gate a surface touch sensor measurement. For example, control circuitry in an electronic device, such as control circuitry 112 of device 10 (FIG. 1) may detect an incoming received communication (e.g., a telephone call, a message, an email, etc.), a reminder, or another operating state of the electronic device. Alternatively or additionally, a sensor in the electronic device, such as a microphone or a motion sensor, may detect the trigger event, such as a speech input or a motion of the device (e.g., a gesture by the user of the electronic device that is measured by the motion sensor). In general, any suitable sensor input and/or operating state of the electronic device may be used as the trigger event to be detected at step 68.

At step 70, after the trigger event has been detected at step 68, one or more taps, interactions, touches, swipes, or other hand gestures may be detected by a surface touch sensor (e.g., surface touch sensor 120 of FIGS. 2-4). The surface touch sensor may be off (e.g., not emitting or detecting light) prior to the detected trigger event, or the inputs to the surface touch sensor may be ignored prior to the detected trigger event. Therefore, in some embodiments, the light emitter of the surface touch sensor may emit light in response to the trigger event.

The surface touch sensor may detect a tap, touch, swipe, or other interaction on an external surface. In some embodiments, the surface touch sensor may determine which finger of a user makes the tap, touch, swipe, or other interaction on the external surface. Alternatively or additionally, the surface touch sensor may detect a touch of the user's additional hand (e.g., a hand gesture) on the hand at which the surface touch sensor is oriented.

In some embodiments, the surface touch sensor may detect multiple inputs, such as multiple taps, touches, or swipes, on the external surface. For example, the surface touch sensor may detect multiple taps that are spaced apart by at least 10 ms, at least 20 ms, at least 30 ms, between 25 ms and 50 ms, or other suitable time.

At step 72, the control circuitry may adjust an operation of the device and/or an external device based on the determined tap or hand gesture. For example, the control circuitry may play or pause music or other audio, skip a song or other audio, adjust the display of the device (e.g., the brightness of the display, the information on the display, or other suitable attribute of the display), answer or reject a phone call, dismiss a reminder, set or clear a timer, set or clear an alarm, call or send a text message to a contact, activate a voice assistant, adjust a volume of the electronic device (or associated speaker/headphones), and/or otherwise adjust the operation of the device. Alternatively or additionally, the control circuitry may send a signal to an external device (e.g., a cellular telephone, a head-mounted device, a computer, etc.) to adjust an operation of the external device based on the tap or hand gesture. In this way, one or more operations of the device (and/or an external device) may be adjusted in response to a tap or hand gesture detected by a surface touch sensor.

As described above, one aspect of the present technology is the gathering and use of information such as information from input-output devices. The present disclosure contemplates that in some instances, data may be gathered that includes personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, username, password, biometric information, or any other identifying or personal information.

The present disclosure recognizes that the use of such personal information, in the present technology, can be used to the benefit of users. For example, the personal information data can be used to deliver targeted content that is of greater interest to the user. Accordingly, use of such personal information data enables users to calculated control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the United States, collection of or access to certain health data may be governed by federal and/or state laws, such as the Health Insurance Portability and Accountability Act (HIPAA), whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select not to provide certain types of user data. In yet another example, users can select to limit the length of time user-specific data is maintained. In addition to providing “opt in” and “opt out” options, the present disclosure contemplates providing notifications relating to the access or use of personal information. For instance, a user may be notified upon downloading an application (“app”) that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of information that may include personal information data to implement one or more various disclosed embodiments, the present disclosure also contemplates that the various embodiments can also be implemented without the need for accessing personal information data. That is, the various embodiments of the present technology are not rendered inoperable due to the lack of all or a portion of such personal information data.

The foregoing is illustrative and various modifications can be made to the described embodiments. The foregoing embodiments may be implemented individually or in any combination.

What is claimed is:

1. A wristwatch device, comprising:
a housing having a front surface, a rear surface, and a sidewall that extends from the front surface to the rear surface, wherein the housing includes a sensor window along the sidewall; and
a surface touch sensor configured to operate through the sensor window, wherein the surface touch sensor comprises a light emitter and a light detector, the light emitter is configured to emit light that reflects off a hand of a user as reflected emitted light, and the light detector is configured to measure the reflected emitted light to detect taps of the hand of the user on an external surface.

2. The wristwatch device of claim 1, further comprising:
a crown on the sidewall, wherein the sensor window is on the crown, and the surface touch sensor is formed in the crown.

3. The wristwatch device of claim 2, wherein the light emitter is configured to emit the light toward a dorsum of the hand of the user.

4. The wristwatch device of claim 1, wherein the light emitter comprises a laser, the light detector comprises at least one photodiode, the surface touch sensor further comprises a beam splitter that is configured to split light from the laser into emitted light and reference light, and the at least one photodiode is configured to measure mixed light that includes the reflected emitted light and the reference light.

5. The wristwatch device of claim 1, wherein the surface touch sensor is configured to vary a frequency of the light emitted by the light emitter with time, the wristwatch device further comprising:
control circuitry in the housing, wherein the control circuitry is configured to detect the taps of the hand of the user on the external surface based on phase changes of the reflected emitted light.

6. The wristwatch device of claim 5, wherein the control circuitry is configured to correlate the phase changes of the reflected emitted light to the taps of the hand of the user on the external surface using machine learning.

7. The wristwatch device of claim 1, further comprising:
control circuitry in the housing, wherein the control circuitry is configured to detect the taps of the hand of the user on the external surface based on the reflected emitted light.

8. The wristwatch device of claim 7, wherein the control circuitry is further configured to detect touches of an additional hand of the user on the hand of the user based on the reflected emitted light.

9. The wristwatch device of claim 7, wherein the light emitter of the surface touch sensor is configured to emit the light in response to a trigger event.

10. The wristwatch device of claim 9, further comprising:
a sensor in the housing, wherein the trigger event is a measurement of the sensor.

11. The wristwatch device of claim 10, wherein the sensor comprises a motion sensor.

12. The wristwatch device of claim 10, wherein the sensor comprises a microphone.

13. The wristwatch device of claim 9, wherein the trigger event is a communication received by the wristwatch device.

14. The wristwatch device of claim 7, wherein the control circuitry is further configured to adjust an operation of the wristwatch device in response to detecting the taps of the hand of the user on the external surface.

15. A wristwatch device configured to be worn on a wrist of a user as the user interacts with an external surface with a hand, the wristwatch device comprising:
a housing having a front surface, a rear surface, and a sidewall surface that extends from the front surface to the rear surface;
a crown on the sidewall surface;
a surface touch sensor in the crown, wherein the surface touch sensor comprises a light emitter and a light detector, the light emitter is configured to emit light that reflects off the hand of the user as reflected emitted light, and the light detector is configured to measure the reflected emitted light; and
control circuitry in the housing configured to detect taps of the hand on the external surface based on the measured reflected emitted light.

16. The wristwatch device of claim 15, wherein the crown is configured to rotate to provide input to the wristwatch device.

17. The wristwatch device of claim 15, wherein the control circuitry is further configured to control the light emitter of the surface touch sensor to emit the light in response to a trigger event.

18. The wristwatch device of claim 17, wherein the control circuitry is further configured to adjust an operation of the wristwatch device in response to detecting the taps of the hand on the external surface.

19. A wearable electronic device, comprising:
a housing having a front surface, a rear surface, and a sidewall surface that extends from the front surface to the rear surface;
a crown on the sidewall surface;
a surface touch sensor in the crown, wherein the surface touch sensor comprises a light emitter and a light detector, the light emitter is configured to emit light that reflects off of a dorsum of a hand of a user as reflected emitted light, and the light detector is configured to measure the reflected emitted light; and
control circuitry in the housing configured to detect interactions of the hand of the user on an external surface based on the measured reflected emitted light and to adjust an operation of the wearable electronic device in response to the detected interactions.

20. The wearable electronic device of claim 19, wherein the housing is configured to be attached to a strap and to be worn on a wrist of the user, and the control circuitry is configured to detect swipes of a finger of the user on the external surface.
